(19) United States
(12) Patent Application Publication
(10) Pub. No.: US 2008/0213735 A1
(43) Pub. Date: Sep. 4, 2008

(54) MANIPULATIVE OBJECT WITH ADHESIVE BACKING

(76) Inventors: Wendy E. Shorr, Lansdale, PA (US); Edwin E. Shorr, Lansdale, PA (US)

Correspondence Address: SYNNESTVEDT & LECHNER, LLP, 1101 MARKET STREET, SUITE 2600, PHILADELPHIA, PA, 19107-2950, US

(21) Appl. No.: 11/935,132

(22) Filed: Nov. 5, 2007

Related U.S. Application Data
(60) Provisional application No. 60/864,245, filed on Nov. 3, 2006.

(51) Int. Cl. G09B 17/00; G09B 25/00; A63H 3/00; A63H 33/00

(52) U.S. Cl. 434/178; 434/428; 446/72; 446/487

(57) ABSTRACT

An educational device having a two-dimensional setting having a smooth surface and at least one three-dimensional manipulative figure and/or object comprising a front side that is 3-dimensional in shape, a backside that is releasably adhereable to said setting. The manipulative can be posable into a desired configuration and can include an internal wire or wires embedded within the manipulative to help make the item posable and able to retain the posed configuration.

### CROSS REFERENCE TO RELATED APPLICATION

This application claims priority to U.S. Provisional Application No. 60/864,245, filed Nov. 3, 2006, and which is incorporated in its entirety herein by reference.

### BACKGROUND

1. Field of Invention

The present invention relates to manipulatives, including figures and/or objects used for educational books and games, and which can adhere to a surface. More particularly, the invention relates to manipulatives that can releasably adhere to a storybook or play board surface.

2. Description of Related Art

Stick-on objects, such as paper dolls and stick-on activity boards and books, are known. Typically, stick-on items involve the attachment of two-dimensional objects, such as caricatures, to an activity board or book by providing a glue or an adhesive, typically on one surface of the object to be attached. Often these items are stickers, designed for one-time use or may be removed and reattached until they lose tackiness, thus these objects have a limited life.

Other objects have a backing of releasable glue or adhesive which is designed to be reusable, albeit for a limited amount of time. That is, the ability to reuse these objects is limited to the extent the backing remains tacky and/or dirt-free. As the adhesive or glue is used, it likely collects dirt and lint on its adhesive surface. The adhesive or glue also tends to wear off after repeated use. Reusable adhesives or glues are, therefore, problematic in that their adhesive ability eventually wanes and fails. Once the objects lose their adhesive properties, they cannot be attached to the play board's or storybook surface, and as such, these objects also have a limited life.

Other stick-on display boards and games achieve adhesion by cohesive force between two interposing surfaces both of which are coated with fabric, felt, nap, flannel, or other material such that their surfaces are fibrous, rutted and/or bumpy such that the two surfaces can “grab” one another and attach by cohesive force. For instance, U.S. Pat. No. 4,403,000 (Gates) includes a display object and display item, both of which are coated with flock, a crushed fibrous material such as rayon. Gates' flock-coated display object and flock-coated display items are releasably secured by cohesive force as the two flock-coated surfaces are coupled and their fibers intermesh and interlock. Gates notes that traditional felt or flannel boards are deficient in that they are limited to one-dimensional, planar applications, and limited to use in a horizontal position as there is not sufficient cohesive force between two surfaces in vertical position to withstand the pull of gravity. Gates seeks to overcome these deficiencies by providing a display object and display item, each attaching to one another other at non-smooth surfaces coated with flock.

Other objects achieve adhesion by static cling. For instance, objects using static cling vinyl, such as Colorforms®, adhere flat, light-weight items of the vinyl material to a flat static cling surface. Static cling vinyl is a special formulation of polyvinyl chloride (PVC) to which a large amount of plasticizer has been added, making it very pliable. Static cling vinyl is considered a “low tack” adhesive as it does not aggressively adhere. When the vinyl is applied to a clean, smooth, glossy surface, it adheres easily. It can be removed and re-applied nearly indefinitely without leaving behind an adhesive residue. (Static cling vinyl is not really an adhesive, but it acts as one when the vinyl is charged using an electrostatic process that provides an attraction to an oppositely-charged surface such as glass.) Conventional objects that utilize static cling vinyl film are conventionally thin and lightweight in order to be used in vertical applications. Moreover, these objects are generally applied to a flat, clean glossy surface, such as glass or specially coated activity board, and therefore are typically limited to one-dimensional or planar applications.

Stick-on objects for vertical applications, such as story books and play boards, conventionally are two-dimensional and lack the capability of being manipulated into various shapes. However, as the demand for more sophisticated manipulatives grows, there exists a need for better objects and figures that are more engaging and allow for more creative and educational play. The present invention satisfies these and other needs in the art.

### SUMMARY OF THE INVENTION

Applicants have invented a novel, fun, and interactive educational device, such as a storybook or a play board, which enables children ranging in age from preschool through early elementary to “act out” real-life activities (e.g., as described in a script) by arranging and manipulating novel three dimensional, posable three-dimensional figures and/or objects that can turn, bend, open/close, or otherwise move. More particularly, the educational device includes one or, or preferably a plurality, of three-dimensional manipulative figures and/or objects that can releasably adhere to the pages of a storybook (i.e., a book with a plurality of flat pages bound along one or more side) or to some type of play board (i.e., a single rigid surface, that is optionally foldable along one or more axes) and also can be arranged into various positions by a user. As used herein, manipulative figures simulate animate beings, such as human- or animal-like figures, and manipulative objects simulate inanimate articles, such as kitchen appliances, doors, furniture, food, etc. The manipulatives can be arranged by bending, pivoting, twisting, or otherwise contorting a portion of the manipulative, preferably at locations that simulate the joints of a corresponding real-life human or animal, or the operation of a real-life object. The manipulatives, therefore, appear to be more life-like and interesting, and thus more engaging, to the child.

In one format, the present invention provides an interactive book that will motivate children to listen and then verbally approximate or “read” the text as he/she “acts out” the activities, depending on the age and ability of the child. In addition, manipulation of the manipulatives involves tactile stimulation and requires the child to use his or her motor skills, as well as spatial reasoning and creative expression. These manipulatives are also much easier for children to grasp than existing colorforms and magnets that are presently being used in the industry. Creative expression is further expanded by releasably adhering the manipulative figure and/or objects to the pages of a storybook or to a play board upon which a setting, such as a kitchen, can be printed or imposed.

Accordingly, one preferred aspect of the invention provides an educational book-like device having two-dimensional, smooth surfaces illustrated to depict a setting, e.g. a kitchen; and at least one three-dimensional manipulative figure and/or object that can be releasably adhered to the surfaces.

### BRIEF DESCRIPTION OF THE DRAWINGS

FIG. 1 shows a manipulative human-like figure releasably adhered to a blank storybook page;

FIG. 2 shows the blank storybook page of FIG. 1 without the manipulative figure;

FIG. 3 shows the blank storybook page of FIG. 2 wherein manipulative appliances of the home setting are opened;

FIG. 4 shows the blank storybook page of FIG. 2 wherein portions of the appliances are open;

FIG. 5 shows manipulative objects and figure releasably adhered to a storybook page having a home setting;

FIG. 6 shows the manipulative objects and figure and storybook page of FIG. 5, but with the manipulative figure moved to another page of the book;

FIG. 7 shows a front-view of a manipulative figure according to the present invention;

FIG. 8 shows a back-view of the manipulative figure of FIG. 7;

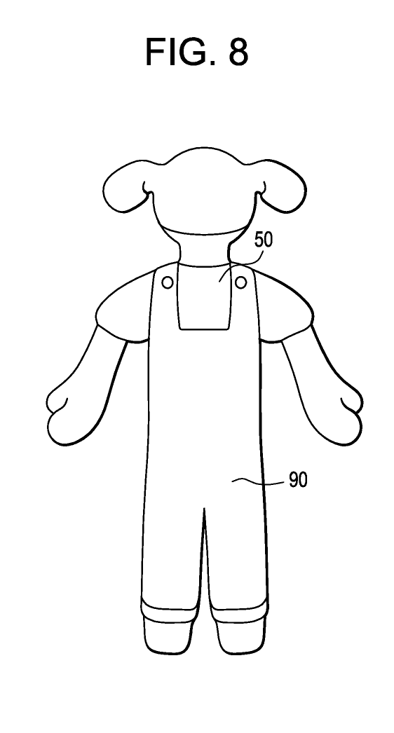

FIG. 9 shows the side-view of the manipulative figure of FIG. 7;

FIGS. 10A-C shows various stages of construction of a manipulative figure;

FIG. 11 shows a manipulative figure having extremities that are bent at the joints: neck, shoulders, elbows, wrists, waist, knees, and ankles; and

FIG. 12 shows a manipulative figure having extremities that are bent about nodal points.

### DETAILED DESCRIPTION OF THE PREFERRED EMBODIMENTS OF THE INVENTION

As shown in the Figures for purposes of illustration, in one form the invention is embodied in an educational device having a storybook or play board to which at least one three-dimensional manipulative figure and/or object releasably adheres. In general, the manipulative has a backing that releasably adheres to surfaces of the storybook or play board without losing its adhesive ability, allowing for repeated adhesion, removal, and reattachment of the figure and/or object to the play board or storybook. In addition, the same manipulatives can be bent, pivoted, twisted, operated or otherwise contorted so that the object can be expressed in a plurality of positions.

### The Manipulatives:

As used herein, the term manipulative means a three-dimensional figure and/or object that can be placed onto a storybook or play board and subsequently removed therefrom or moved to another location on the storybook or play board. In one form, the manipulative can be manipulated into various shapes or positions. For example, the manipulative can be a three-dimensional human figure that preferably is posable. As used herein, the term “posable” means the capacity to be placed or assume and use to hold a particular position or posture. For example, the figure may have bendable joints at its elbows, wrists, knees, ankle, waist, shoulder, neck, etc. so that a user can place the figure in a specific posture which is generally maintained until the user re-positions the figure. As another example, a manipulative can be a three-dimensional shaped object, such as a stove having doors that open, or a napkin that can be folded. Three-dimensional manipulatives also include objects that can be removably placed onto a storybook or play board, but which cannot be bent or shaped such as a plate or fork.

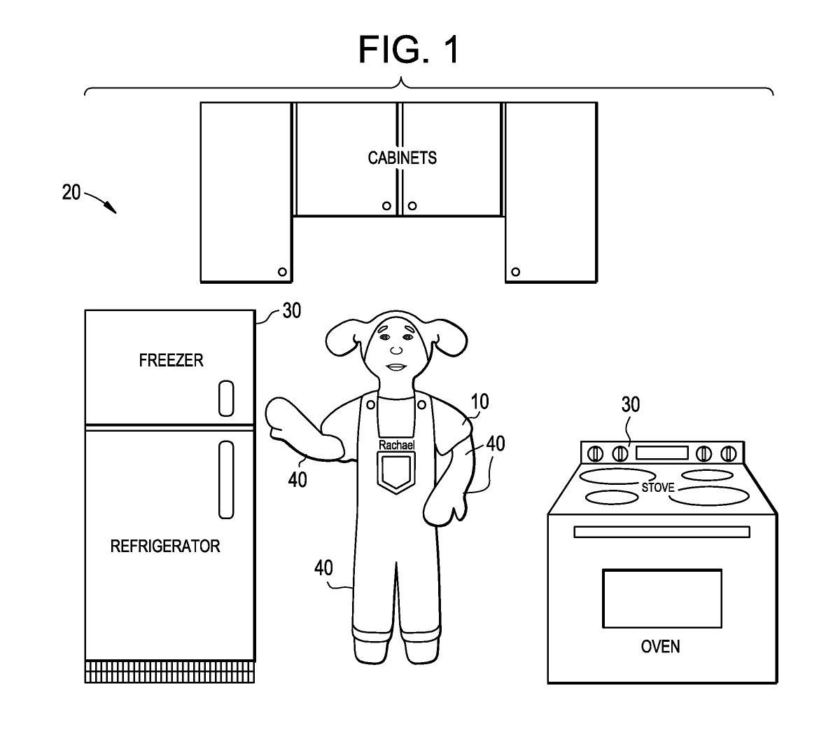

Turning to FIG. 1, a manipulative 10 in the form of a human-figure is shown releasably adhered to a storybook page 20 having a home setting. Manipulative appliances and fixtures 30 are releasably attached to the storybook page 20 as well. One manipulative 10 shown in FIG. 1 is a figure of a little girl. Other manipulatives, such as animals, furniture, appliances and fixtures, household goods, and the like, are also contemplated by the present invention.

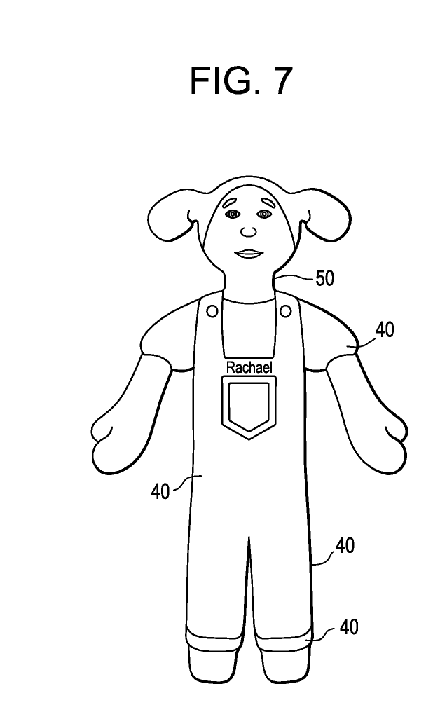

The illustrated manipulative 10 has one or more nodal points 40 to facilitate bending, twisting, rotating, flexing, or otherwise contorting a limited portion of the object. In certain embodiments, the nodal points are disposed at locations that would correlate to joints of the real object being simulated. For example, when the manipulative is a human-like figure, the nodal points can be located within the figure and/or object at one or more of the following locations: neck, shoulder, elbow, wrist, back, hip, knee, ankle, and the like. The manipulative shown in FIG. 7, for example, has nodal points 40 at the elbows, knees, hips, and ankles. The elbow nodal point, for example, facilitates bending of the figure forearm by reducing the amount of torque transferred to other portions of the figure's body beyond the nodal point.

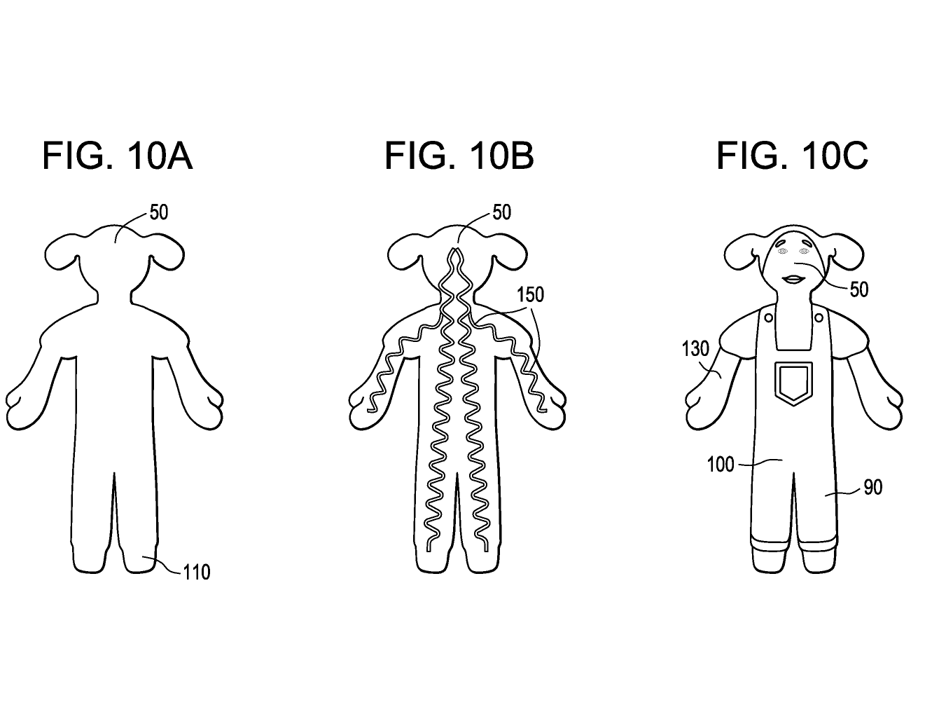

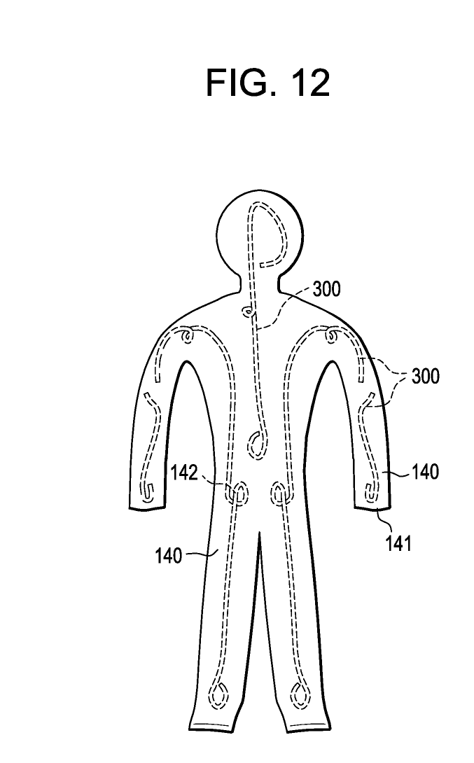

Referring to FIGS. 10A-C, the manipulative 50 has an internal, non-exposed z-shaped wire frame 150 disposed inside an figure having a front side 100 and a back side 90. The wire frame 150 imparts an overall rigidity to the figure, while allowing the figure to be posable as desired. In certain preferred embodiments, such as the one shown in FIG. 12, the wire frame comprises a plurality of different, unconnected wire segments 300. In other embodiments, the wire frame is constructed of a single wire, or a plurality of connected wire segments.

The wire frame is preferably constructed of any suitable material, such as steel, copper, nickel, or a metallic alloy or composite. The wire frame may be constructed of sheathed wire that is encased in foam, cloth, plastic, or some other material to protect the wire from corrosion; solid wire; or stranded wire may also be suitable. For rigidity, solid wire is preferred.

The diameter of the wire used in the wire frame is not particularly limited, except that it must impart the desired characteristic of overall rigidity to the figure and/or object and flexibility. The wire can range from 10 to 24 gauge, for example, 22 gauge, 20 gauge, 18 gauge, or 16 gauge, and can be sheathed or unsheathed. The lower the gauge (i.e., larger diameter), the more rigid the wire becomes. For small figures, a wire frame constructed of higher gauge wire is preferred to facilitate the bending of the figure's extremities. For large figures, a wire frame constructed of a lower gauge wire is preferred in order to maintain a relative amount of rigidity to the figure's overall structure. Lower gauge wire does not adversely affect the flexibility of a larger figure's extremities (i.e., head, arms, and legs) because the larger extremity allows the user to leverage more force in order to manipulate the extremity. In certain embodiments, the figure may be constructed of different sized wires in order to better balance rigidity and flexibility. For example, a figure's wire frame can comprise a frame of larger wires at its trunk and a frame of smaller wires or stranded wires at its hands and feet.

In certain preferred embodiments, the wire frame can include a nodal point 140, such as the loop shown in FIG. 12. This loop may occur at an intermediate position in the wire section 142 or at the terminal end of the wire section 141. Compared to straight wiring, these loops improve the movement of the figure and/or object. More particularly, a loop increases the flexibility of the wire at the loop and also localizes point of movement at the loop so that the movement, e.g., a twist of the leg, does not extend beyond the nodal point.

Other types of nodal configurations may be acceptable, including a “z-shaped” bend 150 in FIG. 10B. Compared to straight wiring, the “z” pattern improves the movement of the figure or object. More particularly, straight wiring turns inside the manipulative, making posing and reshaping impossible to achieve. The “z” pattern, on the other hand, will not turn to any appreciable extent, thus increasing flexibility of the wire, improving the range of movement of parts of the figure thereby simulating more natural movement of the body (e.g., walking, bending, kicking, waving hands, nodding head, etc.). The “z” shape also improves the reshapability of the object into different positions.

In certain preferred embodiments, the body of the manipulative figure and/or object is from about 2 to about 10 inches in length. The range of 2 to 10 inches represents a size figure and/or object that a child could comfortably play with and easily manipulate. Figures and/or objects that are larger than 10 inches in length may be too cumbersome for children to manage and may be easily be incorporated into a storybook or play board. However, manipulatives are not necessarily confined to this range and could be of any practical length depending upon the particular application. In one preferred embodiment, the manipulative 50 is about 2 mm to about 8 mm thick.

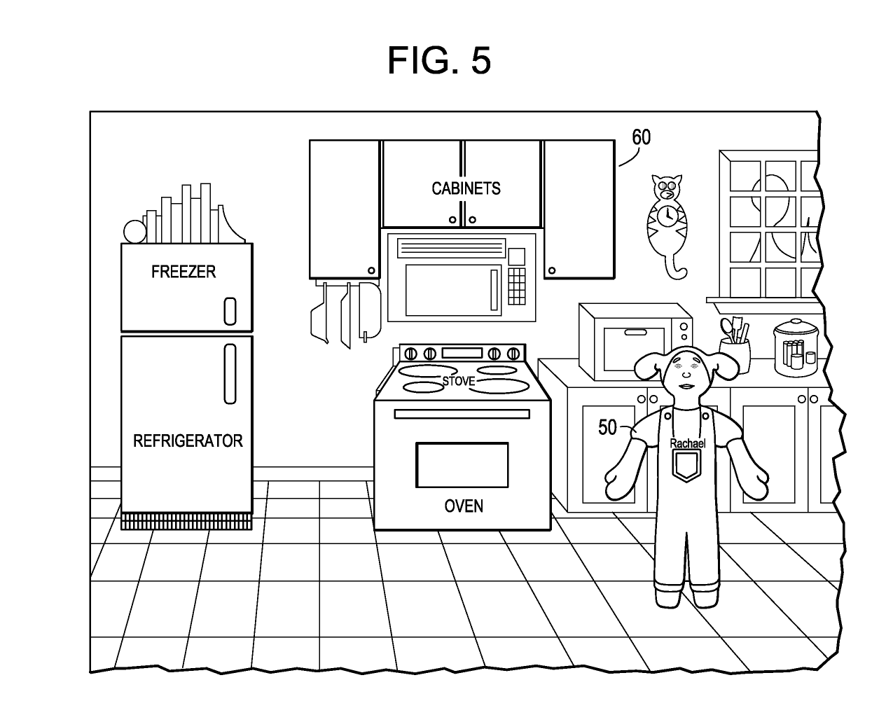

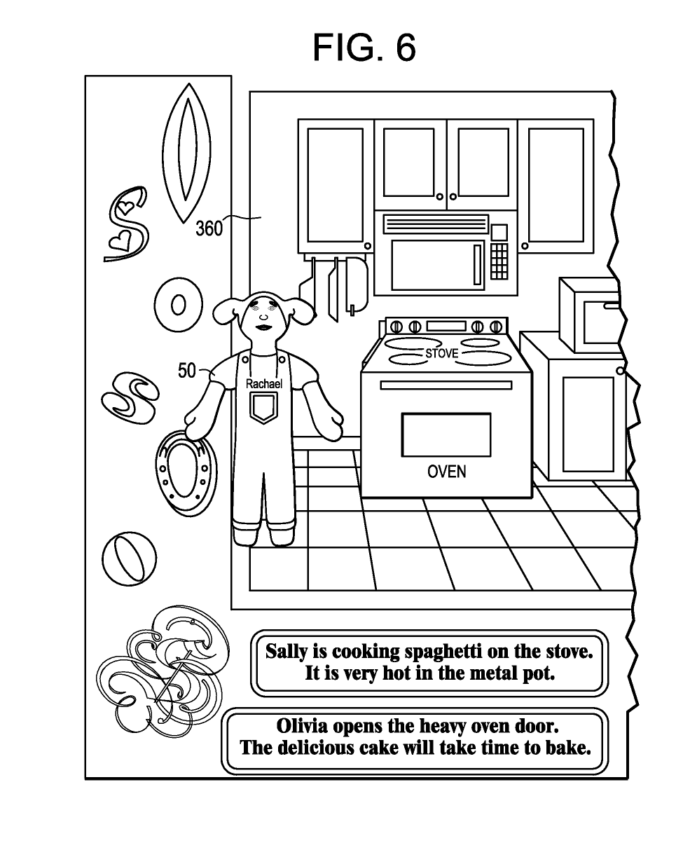

The backside of the manipulative contacts the play board or storybook when the figure is attached to it. Preferably, the back side of the manipulative includes a layer of releasable adhesive material on its external surface. This layer enables the manipulative to releasably attach to the surface of a storybook or play board, to subsequently be removed from the storybook or play board, and then reattached to the same or different location in the storybook or on the play board. For example, as shown in FIG. 5, a manipulative 50 adheres to the surface of a storybook 60, but is releasable and, therefore can be moved to another location or page 360 in the storybook as shown in FIG. 6.

In certain embodiments, the back side of the manipulative includes a flat surface on which the layer of releasable adhesive material is attached. The flat surface maximizes the surface area that contacts the storybook or play board, thus maximizes the adhesive force between the figure and/or object and the board or book. The releasable adhesive can be any material that can releasably adhere the manipulative to the play board or storybook, such as static cling vinyl, felt, chemical adhesives, magnets, and the like. In certain highly preferred embodiments, the back side 90 includes a layer of static cling polyvinyl chloride. Embodiments utilizing static cling polyvinyl chloride are advantageous in that they provide a surface that is soft and pliable; that retains its capacity of adherence after repeated attachments and removals; that can be removed without leaving behind an adhesive residue; that is safe and non-toxic; and that is relatively inexpensive to produce and incorporate into the manipulative object.

In another preferred embodiment, magnets can be used. A magnet can be attached to the manipulatives (either inside or in back) and the storybook and/or play board can contain magnetically attractive material, or vice versa.

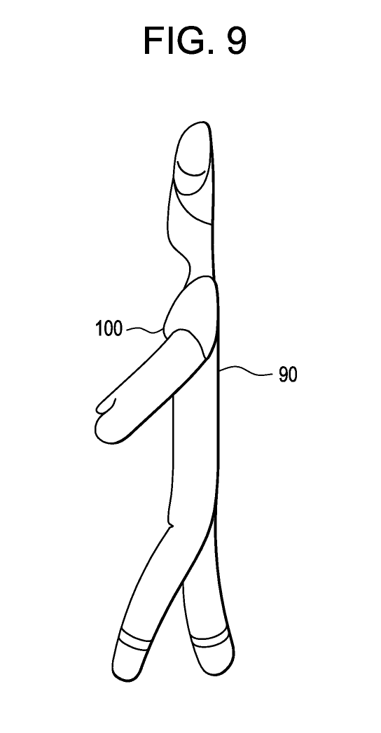

The front side 100 preferably faces the user once the manipulative object is attached to the storybook or play board, and preferably is three-dimensional. Preferably, the front side of the FIG. 50 has detailed features, such as a face with eyes, nose, mouth, hair, etc. Referring to FIG. 9, the front side 100 of the FIG. 50 preferably is sculpted to provide a three-dimensional look that, when compared to a two-dimensional object, more closely resembles a person or other tangible creature. Examples of sculpting include molding, carving, casting, and the like.

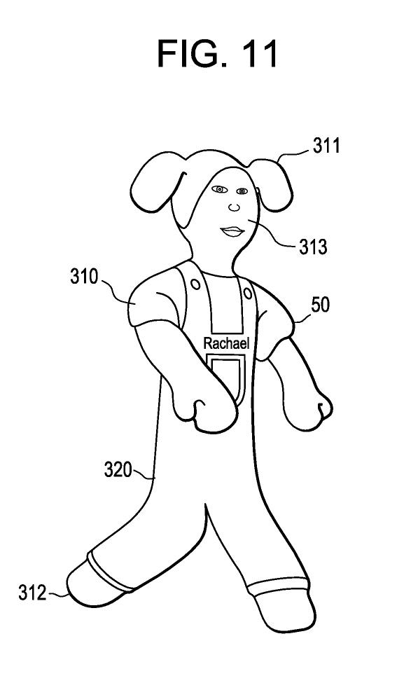

FIG. 11 shows a manipulative FIG. 50 with nodal points at the shoulder 310 and hip 320. In addition, the figure is marked to provide the appearance of shoes 312, a face 313, and hair 311. An alternative to marking a manipulative with certain features such as shoes, involves the fashioning of such features from materials similar to, or different from, the material(s) of the manipulative. Other features, such as eyes, hair, clothes, and the like can also be fashioned separately from the manipulative itself. Such separately fashioned elements provide the manipulative with a more realistic and life-like appearance compared to similar elements that are painted or otherwise marked on the manipulative itself.

Referring now again to FIGS. 10A-C, shown is one method of assembling and constructing manipulatives according to the present invention. In FIG. 10, a first portion 110 of a figure is provided. A wire frame 150 is then disposed on the first portion, after which a second portion 130 is added to cover the wire frame and to complete the form of the figure. Alternatively, a wire frame may be held in place while the entire body of the figure is formed around it.

The body of a manipulative figure and/or object, which surrounds the frame, can be constructed, for example, of foam, rubber, plastic, vinyl or cloth. Preferably, the body is constructed of a material such as flexible polyurethane foam, that is soft and pliable and also can be sculpted into a three dimensional form, such as an anterior portion of person. It is also desirable that the material forming the figure's body is capable of being dyed, painted, or otherwise marked so as to resemble human features such as eyes, hair, and a mouth.

### The Setting:

The storybook or play board of the present invention provides a setting for applying the manipulatives. Storybooks can have rigid or flexible pages. Likewise, the play board can be flexible or rigid. The surface of the storybook pages or the surface of the play board is preferably constructed of a material that facilitates the adhesion of the manipulative figures and objects. The surface may also be treated or otherwise processed to facilitate such adhesion. In certain preferred embodiments the surface is flat or two dimensional to maximize the available surface contact area with the corresponding flat backing of the manipulative. Maximizing the contact surface area provides the strongest overall adhesion between the figure and/or object and the storybook or play board. Since the manipulatives are constructed of a releasably adhesive material, they can be taken on and off of the book pages or playboard numerous times without losing their ability to stick.

Also, for embodiments that utilize a static cling polyvinyl chloride backing for the manipulative, the surface of the storybook or play board is preferably constructed of a smooth layer of static cling polyvinyl chloride or other material that can hold a static charge. Such materials complement the backing material of the manipulative, thus providing good adhesive force between the figure and/or object and the storybook or play board.

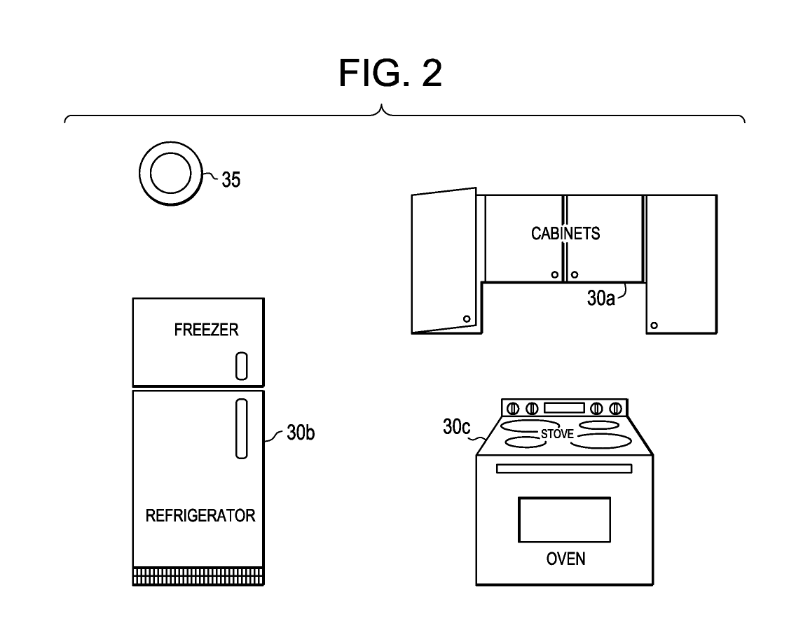

The storybook page 20 shown in FIG. 2 has a home decor that includes domestic appliances and fixtures. Here, the cabinets 30a and refrigerator 30b are manipulative objects that can be removably attached anywhere on the storybook page, and have doors that open. The dish 35 is a non-bonding manipulative that can be removably adhered to the storybook page on any location. Although a home setting is shown in this Figure, it is contemplated that the present invention can utilize other settings without particular limitation. For example, the settings may include a farm setting having tractors, barns, fences, crops, domestic animals, and the like; a castle setting having a moat, stone walls, windows, bridges, and the like; a countryside setting having a meadows, trees, wild animals, flowers, and the like; a seascape having a beach, ocean, fish, sea shells, sea birds, coral reefs, and the like; a science fiction setting having space ships, planets, stars, moons, aliens, and the like; or a fantasy land having woods, meadows, and fantasy creatures such as fairies, dwarfs, wizards, pixies, dragons, unicorns, leprechauns, knights, princesses, and the like.

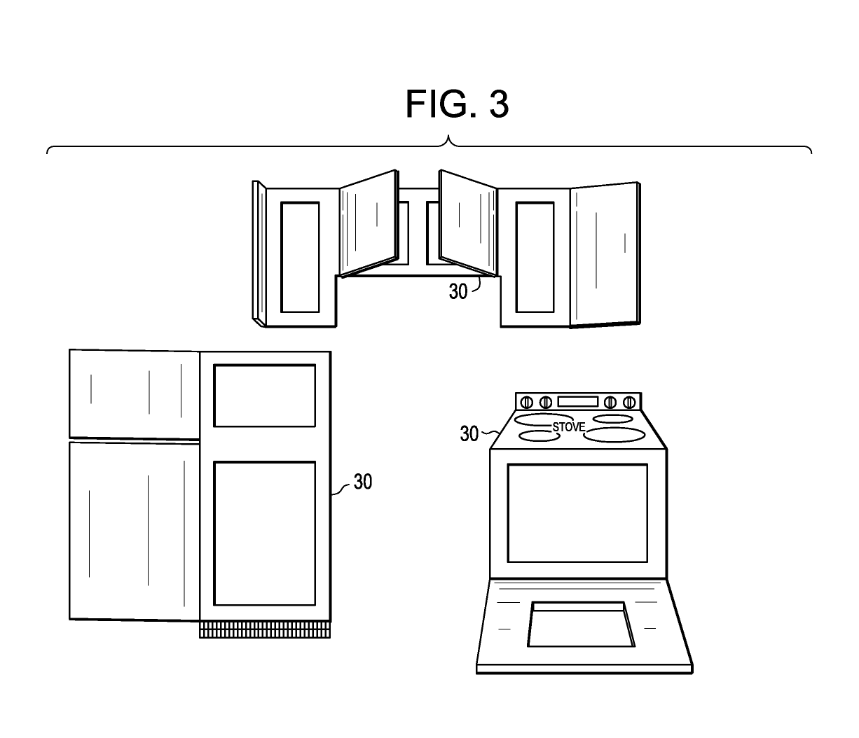

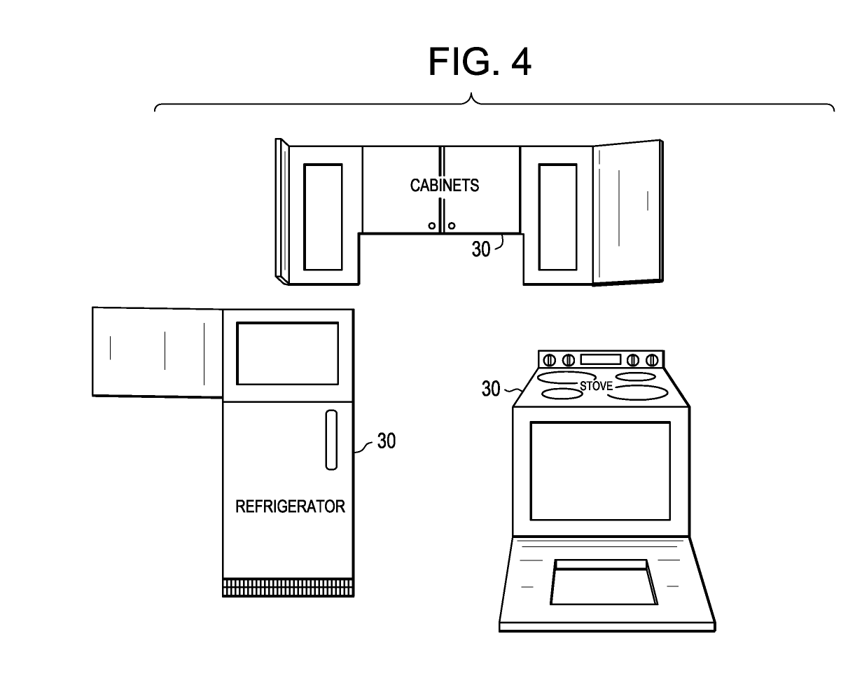

The manipulative appliances and fixtures depicted in FIG. 1-4 can be three-dimensional and have movable parts, such as hinged doors that open and close. Preferably, static cling will be used as the hinges. Flat, two-dimensional settings are particularly preferred for embodiments in the form of storybooks, where there are multiple pages bound together.

In the illustrated embodiment, some of the fixtures, appliances, and other domestic items are permanently affixed to, or printed on, the play board or storybook, other items are printed or embossed onto the play board or storybook. In addition to the fixtures, appliances, and other domestic items, other features of the home may also be portrayed on the play board such as windows, stair cases, furniture, rugs or carpets, painted walls, pictures, and the like.

### EXAMPLE

This example illustrates the invention embodied as a bound children's book.

Each page of the book will contain: an illustration of a section of the kitchen, three dimensional figure(s) (i.e., the character(s) of the activity or story), three dimensional object(s) (i.e. an appliance, cabinet, table, utensil, cup, food, etc.), and the written text. The objects that have doors will all be able to open and close for greater realism. The last two pages of the book will be the illustration of the entire kitchen. The children will be able to take the manipulatives from the pages of the book and match them to their corresponding pictures on these last two pages, if they so desire. This will teach or reinforce their matching skills. The children will also be able to either retell the story they just heard, and/or should also be encouraged to create their own stories, allowing for countless opportunities for initiating oral language, either alone or with others. In addition, the manipulatives can represent any desired culture or ethnic backgrounds, e.g. White, Black, Asian, and Hispanic.

The book will incorporate all of the important areas of literacy development. The text on each page of the book will be comprised preferably of about two to four sentences. The first sentence on each page will contain three to five examples of alliteration, and will be written in either the present progressive verb form or the present tense. A variety of nouns, verbs, and adjectives are used to increase vocabulary. The second sentence on each page will be a rhyming sentence. Many of these sentences will either describe an attribute of the object in the first sentence or describe the function of the object being talked about in the first sentence. Fifty percent of these rhyming sentences will be written in the future tense. The present progressive verb tense, the present tense, and future tense are all basic grammatical forms that preschool children will be learning to use. All of the three dimensional characters in the book will have their names printed on their shirts, and all of the three dimensional objects will have their printed labels on them. This will help children associate words with objects, and reinforce the idea that words and names are made up of letters, and that letters stand for the sounds we make when we say the words.

The first two pages of the book (before the text and illustrations) will contain written text describing 22 “Suggestions For Use”. These are intended to further increase the children's engagement and active participation in the book reading process, create a dialogue with a participating adult, provide adult models for language, expand children's expressive and receptive language skills, increase children's concept development and enhance children's emergent literacy growth.

### Suggestions for Use

“This interactive book was created to help strengthen, teach, or improve literacy skills in a fun, “hands on”, highly motivating format, using very familiar objects and illustrations. General and special education children ranging in age from preschool through early elementary grades will all learn skills at their own level of ability. The following are suggested activities to do with the child in addition to reading aloud or having the child read aloud.”
Note: 1. Always begin by modeling some or all of the correct answers.
   2. When applicable, the adult should be encouraged to repeat and expand on what the child(ren) say, creating a dialogue and providing adult models of language.
   3. Remember to give praise and encouragement for the child(ren)'s effort and participation.
   4. Make this a fun experience!

### Ask the Child to:

1. Say all the words in the first sentence that begin with the same letter (alliteration). Name this letter and point to all of these letters on the borders of each page. Say the beginning letter of each character's name. Say what letter their name begins with, your name, other family members' names, etc. Make the sound of each of the letters as you are doing this activity.
2. Say the two rhyming words in the second sentence on each page.
3. Clap for each syllable after you say each two, three, four, and five-syllable words that occur throughout the book.
4. Pick-up the three dimensional object that you name (line up 3 or more objects depending on the ability of the child).
5. Match the three dimensional objects to the corresponding illustrations on the last two pages. Say all the letters on each object.
6. Follow your verbal directions. These directions can be one-step, i.e. “Open the oven door”; two-step, i.e. “Pick-up the fork and give it to me”; three-step, i.e. “Pick up the raspberries, put them on the table, then open the freezer door”, etc.
7. Follow your verbal directions using the spatial words “in, on, under, in front of, in back of/behind, next to or beside, above, and below” (some directions can be silly to increase the fun); i.e. “Put the cake in the toaster oven”, “Put the sippy cup on the spoon”, “Put the napkin under the plate”, “Put Rachael in front of the refrigerator”, “Put Tommy in back of/behind the table”, “Put the spoon next to (beside) the plate”, “Put the pot above the stove”, “Put the crackers below the cabinets”, etc.
8. Name as many of the three dimensional objects as possible. Discuss the fact that: the word “silverware” refers to a fork, spoon, and knife, and they can also be called “utensils”; and that the word “appliance” can refer to a toaster oven, refrigerator, stove, microwave, and dishwasher. Name other utencils (i.e. spatula, ladle, etc.), and name other appliances. Name “parts” of the objects, i.e.: handle of the cup, fork, spoon, pot, oven door, dishwasher, refrigerator; tines or prongs of the fork, dials on the stove and toaster oven; “legs” of the table; buttons on the dishwasher; faucet or spigot, drain of the sink, etc.
9. Name other things that are: warm, hot, cold, frozen, big, neat, messy, dirty, clean, salty, sticky, heavy, red, made of metal, made of plastic, and rectangular shaped.
10. Name other fruits besides ‘raspberries’.
11. Name other foods that you: put in the toaster oven; cook on the stove; bake or cook in the oven; cook in the microwave; put in the refrigerator; and put in the freezer.
12. Name foods that are packaged in boxes and cans.
13. Describe the functions of the objects; i.e. “What do we do with a: toaster oven, an oven, stove, cabinets, refrigerator, freezer, dishwasher, microwave, spoon, fork, knife, napkin, cup, table, and sink.”
14. Say what each character is doing using the pronouns ‘he’ or ‘she’; i.e. When asked “What is Sally doing?“, the child responds “She is cooking spaghetti on the stove”.
15. Say what each character did using the past tense, i.e. “Sally cooked spaghetti on the stove”; “Carlos stacked plastic cups in the cabinet.”; etc.
16. Respond to “When” questions, i.e. “When do we eat breakfast?”, “When do we eat lunch?”, “When do we eat dinner?”, etc.
17. Respond to “Where” questions, i.e. “Where do we pour milk?” , “Where do we put a cake to bake it?”, “Where do we put dirty dishes?”, etc.
18. Respond to “Who” questions, i.e. “Who is taking toast out of the toaster oven?” “Who is filling the freezer with food?”, etc.
19. Respond to “Why” questions, i.e. “Why do we put food in the refrigerator?”, “Why do we wash dishes?”, “Why do we use a napkin?“Why is there a drain in the sink?”, etc.
20. Make predictions. Ask the child questions such as: “What would happen if you touched a hot pot?”; “What would happen if you left a cake in the oven too long?”; “What would happen if you didn't put ice cream in the freezer?”, What would happen if you ate soop with a fork?”, etc.
21. Describe the steps involved in: baking a cake, cooking spaghetti, setting the table, making a sandwich, etc.
22. Use the last two pages to create their own story. This will give the child(ren) countless opportunities to use oral language. It is also a wonderful way for caregivers and children to interact together.”

### The Following are All of the Lines of the Text for a Book: OUR HAPPY HOUSE-IN THE KITCHEN

### Page 1

Our kitchen is where we always meet,
To cook and bake, talk and eat.
Come join us now and see everyone,
We are going to have so much fun.

### Page 2

Tai is taking the warm toast out of the toaster oven.
The jelly will be spread on the toasted bread.

### Page 3

Rachael puts red raspberries in the refrigerator.
Truth be told, brrrr, it's cold.
Faith fills the bitter cold freezer with food.
Ice cream, ice pops we all shout, frozen 'til we take them out.

### Page 4

Sally is cooking spaghetti on the stove.
It is very hot in the metal pot.
Olivia opens the heavy oven door.
The delicious cake will take time to bake.

### Page 5

Cousin Carlos pulls out crackers from the cabinet.
Boxes, cans, and dishes go in here, stored away but always near.

### Page 6

Tommy sets the rectangular shape table tonight.
On it goes plates, cups, and silverware, which he will place with special care.

### Page 7

Nancy neatly puts the napkins next to the forks.
It's there to use just in case, we get food on our hands and face.

### Page 8

Our friend Frank eats salty French fries with his fork.
They are yummy in his tummy.

### Page 9

Sam is sipping hot soup with a spoon.
Slurp, slurp, soon he will burp.

### Page 10

Mom makes buttered popcorn in the microwave.
After it pops, the microwave stops.

### Page 11

Sister Sue washes the sticky sippy cup in the sink.
Soap up and rinse is what we do, to make the cup clean as new.

### Page 12

Dad is loading the dirty dishes in the dishwasher.
Wash the mess away, as we go and play.

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting.

What is claimed is:

1. An educational device comprising:
a. a setting having a two-dimensional surface; and
b. at least one manipulative figure having a front side that is 3-dimensional in shape, a backside that is releasably adhereable to said setting, and at least one posable portion that can be repeatedly bent, twisted, pivoted, stretched, or turned.

2. The educational device of claim 1 wherein said backside comprises a static vinyl material capable of releasably adhereing to said setting.

3. The educational device of claim 2 wherein said static cling vinyl comprises polyvinyl chloride and at least one plasticizer.

4. The educational device of claim 1 wherein said positionable portion is disposed at one or more locations selected from the group consisting of: ankles, knees, hips, back, wrists, elbows, shoulders, and neck.

5. The educational device of claim 1 wherein said manipulative includes a metallic “z” shaped wire disposed within said manipulative in said positionable portion.

6. The educational device of claim 5 wherein said “z” shaped wire includes terminal loops.

7. The educational device of claim 1 wherein said manipulative comprises an internal wire having looped nodal points disposed in said positionable portion.

8. The educational device of claim 1 wherein said manipulative is constructed of at least one material selected from the group consisting of pliable foam, rubber, plastic, vinyl and cloth.

9. The educational device of claim 1 wherein said setting is disposed within a storybook comprising multiple pages bound together.

10. The educational device of claim 1 wherein said setting is disposed on a play board.

11. The educational device of any of claim 1 wherein said figure is a person, animal, or mythical creature.

12. The educational device of claim 11 further comprising at least one manipulative object having a front side that is 3-dimensional in shape, a backside that is releasably adhereable to said setting, and at least one positionable portion that can be repeatedly bent, twisted, pivoted, stretched, or turned.

13. The educational device of claim 12 wherein said backside of said manipulative object comprises a static vinyl material capable of releasably adhereing to said setting.

14. The educational device of claim 13 wherein at least one of said manipulative objects includes a hinge made of static vinyl.

15. The educational device of claim 12 further comprising a second three-dimensional manipulative object that is not posable.

16. A manipulative figure, comprising a body having a front side having a 3-dimensional shape; a flat backside that is releasably electrostatically adhereable to a flat rigid surface; and at least one posable portion that can be repeatedly bent, twisted, pivoted, stretched, or turned.

17. The manipulative figure of claim 16 wherein said backside comprises a static vinyl material.

18. The manipulative figure of claim 16 wherein said positionable portion is disposed at one or more locations selected from the group consisting of: ankles, knees, hips, back, wrists, elbows, shoulders, and neck.

19. The manipulative figure of claim 16 wherein said body further comprises a metallic “z” shaped wire disposed within said body in said positionable portion.

20. The educational device of claim 19 wherein said body is constructed of at least one material selected from the group consisting of pliable foam, rubber, plastic, vinyl and cloth.
